(19) United States
(12) Patent Application Publication
(10) Pub. No.: US 2008/0115004 A1
(43) Pub. Date: May 15, 2008

(54) Clock Skew Adjustment Method and Clock Skew Adjustment Arrangement

(75) Inventors: Florian Braun, Stuttgart (DE); Willm Hinrichs, Holzgerlingen (DE); Cedric Lichtenau, Stuttgart (DE); Thomas Pflueger, Leinfelden (DE)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, Armonk, NY (US)

(21) Appl. No.: 11/938,835

(22) Filed: Nov. 13, 2007

(30) Foreign Application Priority Data
Nov. 15, 2006 (DE) 06124166.7

(51) Int. Cl. G06F 1/12

(52) U.S. Cl. 713/401; 713/503

(57) ABSTRACT

A clock skew adjustment arrangement for a chip is provided which chip is subdivided in at least two blocks, wherein the blocks are supplied with a clock signal of a single joint clock signal generator via clock signals paths, and wherein to each block a circuitry is assigned for measuring and adjusting the respective clock signal.

### SUMMARY OF THE INVENTION

The chip is subdivided into several blocks. A block can be a small group of devices, a unit like a floating-point or vector unit, a core or even a specialized accelerator. Some blocks may be dynamically powered on and off during operation of the chip, some may just have varying activity and some may have voltage according to their activity. For example, an encryption block is powered on only if needed, the core drops its voltage if it is not highly active etc.

According to the invention a clock skew adjustment arrangement is proposed, wherein a chip is subdivided in at least two blocks, and wherein the blocks are supplied with a clock signal of a single common clock signal generator via clock signals paths. A circuitry is assigned to each block for measuring and adjusting the clock signal. Preferably the circuitry comprises at least one detection circuit for determining the local skew of the clock signal in the block and at least one delay control circuit per block for adjusting the delay for compensation of the global skew. By adjusting the local clock signal skew according to the measured clock signal skew, a global clock signal skew between the blocks can be adjusted and thus preferably minimized.

The circuits are provided as logic macros in the circuit design flow. The clock signal generator which provides the clock signal for the blocks can be a phase locked loop, a logical pin, an oscillator or the like.

The detection and delay control circuits serve as control and sense blocks for the feedback of the blocks to the joint clock signal generator. These circuits can be comparably slowly because they are not supposed to intervene in each clock cycle.

The arrangement can compensate and adjust local clock signal skew in a block on the fly and can generate synchronous clock signals with minimum skew in all blocks.

The invention allows applying synchronous clock signal methods to the design of the chip even when blocks vary in clock signal propagation, for example due to electrical activity, temperature, voltage, power planes and the like. Timing analysis can be done with minimal margins since the global clock signal skew can be kept to a minimum automatically during operation so that the frequency and the performance of the chip can be increased. Furthermore, multi-core chips can be put together from building blocks, even heterogeneous building blocks, with a trivial chip-level clock mesh, reducing the time-to-market. Favorably, blocks may be used even from previous designs. The invention is especially favorable for chips with multiple cores embedded in multiple power planes.

According to a particular embodiment, each block comprises a local clock distribution (clock mesh/clock tree) for distributing an incoming clock signal. Preferably, the clock meshes/clock trees are independent from each other. Independent power domains for the blocks are possible. The skew between a block's clock signal and a reference clock signal is determined. According to the local skew a delay adjustment is calculated for each block. Adjusting the clock signal in the block means also adjusting the global clock signal skew between the blocks.

One detection circuit is assigned to each block. Preferably, the detection circuit comprises a path of delay elements and storage elements wherein after each delay element the current state of the local skew is stored. For example, the storage elements can be latches and/or flip-flop-elements.

A reference clock signal can be provided for triggering the storage elements.

A delay control circuit is assigned to each block. The delay control circuit is adapted for being dynamically adjustable. The necessary adjust can be set dynamically for each block.

After power-on the (independent) clocks of the different blocks are synchronized by calibrating each block adjust. This takes into account the static delays caused by process variations as well as dynamic delays. When the blocks warm up due to e.g. high activity on the chip, the clock signal delay can be tracked as the temperature changes and the clock signal delay can be adjusted dynamically. The clock signal skew can be kept at a minimum. When one or more individual blocks enter a power-saving mode, the respective block area cools down compared to other active chip areas. When exiting a power-saving mode the clock signal for these individual blocks can be recalibrated to match the other blocks on the chip.

According to a particular embodiment, each clock signal path to each block comprises at least one delay control circuit. The delay control circuit is preferably a macro. The delay can be adjusted dynamically to compensate for the clock skew. The delay value can be determined from the measured clock signal skew.

In principle, the detection circuit and the delay control circuit can be arranged independently from each other on the chip. They can be placed outside the blocks on a global area of the chip or integrated into the blocks.

The delay control circuit can be integrated into a clock distribution present in the block, thus saving space on the chip. This arrangement is also very transparent to physical designers.

In a particular embodiment, the delay control circuit comprises multiple paths with selectable different delays. Preferably the selection is made by at least one multiplexer. The multiplexer selects the desired delay path. Instead of one or more multiplexers, other selection devices or circuits are possible.

In a space-saving arrangement the detection and delay control circuits are integrated into the blocks. This can be done for both circuits or only one of them is integrated into the block. Building blocks can already be preplaced and prerouted from earlier designs, which is cost efficient. The blocks own independent clock distributions. A simple clock signal connection can be used such as a simple top level clock signal. Therefore, blockages in blocks can be avoided.

A clock skew adjustment method for a chip subdivided into at least two blocks is proposed, wherein the blocks are supplied with a clock signal of a single common clock signal generator via clock signals paths, comprising: measuring a local skew of the clock signal in each block and adjusting the global skew for each block. The method does not change the feedback to the clock signal generator. Instead, the generator is always locked. For each block, a local feedback is provided via detection and skew delay circuits. If one block is powered off, its local feedback is also switched off. On power-on, the block can be synchronized immediately within only a few clock cycles, because only the delay has to be adjusted. It is not necessary to wait until the clock signal generator has been synchronized, as nothing is changed with the generator. It is also not necessary to wait until the block has warmed up, because the delay is tracked continuously.

Each block can supply a feedback clock signal which is compared to a reference clock signal in a detection circuit. Adjustment of the local clock skew can be estimated based on the comparison of the measured clock signal and the reference clock signal for each block. For adjustment of the global clock signal skew a required clock signal delay is determined for each block. The clock signal delay can be adjusted in small increments so that a local clock frequency shows only tolerable variations during adjustment. The clock signal delay can be adjusted dynamically.

The local clock signal skew can be determined by means of a detection circuit comprising a path of delay elements, wherein after each delay element a storage element stores the actual state of the local clock signal skew. By measuring the local and adjusting the global clock signal skew it is possible to reduce a global clock signal skew between the individual blocks on the chip.

The local clock signal skew can be adjusted by means of a delay control circuit, wherein a specific delay is selected. A multiplexer which selects the specific delay path or another selection device or circuit can do selection.

On power-up of the chip, initial delays can be made. All blocks can be synchronized on system start-up. This handles all static delays.

Using the skew detection/delay adjustment method according to the invention does not only help for dynamic adjustments, for example for voltage and/or temperature changes, but also helps for integration of building blocks on the chip. With a set of cores, accelerators and other blocks, different chips can be implemented very easily by putting these blocks together. Normally, the global clock signal must be analyzed and adjusted for static skew balancing which results in different blockages on the top metal layers for each block. This means that either these layers cannot be used in the blocks or some work has to be done to work around these blockages, which means customizing the blocks for every new chip. With the delay book (delay control circuit) according to the invention, each block can favorably have its own clock distribution (clock tree/clock mesh) which adapts automatically to the reference clock signal on the chip.

### BRIEF DESCRIPTION OF THE DRAWINGS

Various embodiments of the present invention are hereinafter described in conjunction with the appended drawings:

FIG. 1a and FIG. 1b illustrate a connection from a clock signal generator to two blocks of a chip (FIG. 1a) and clock signals of the two blocks exhibiting a clock signals skew compared to a reference clock signal (FIG. 1b);

FIG. 2 illustrates a top view of a preferred chip which is subdivided into several blocks with a common clock signal generator according to the invention;

FIG. 3 illustrates a preferred connection between a clock signal generator and a block with detection and delay control circuits assigned to the block;

FIG. 4 illustrates a embodiment of a detection macro; and

FIG. 5a and FIG. 5b illustrate a first embodiment of a delay control macro with multiple multiplexers (FIG. 5a) and a second embodiment of a delay control macro with a single multiplexer (FIG. 5b).

It is to be noted, however, that the appended drawings illustrate only example embodiments of the invention, and are therefore not considered limiting of its scope, for the invention may admit to other equally effective embodiments.

### DETAILED DESCRIPTION

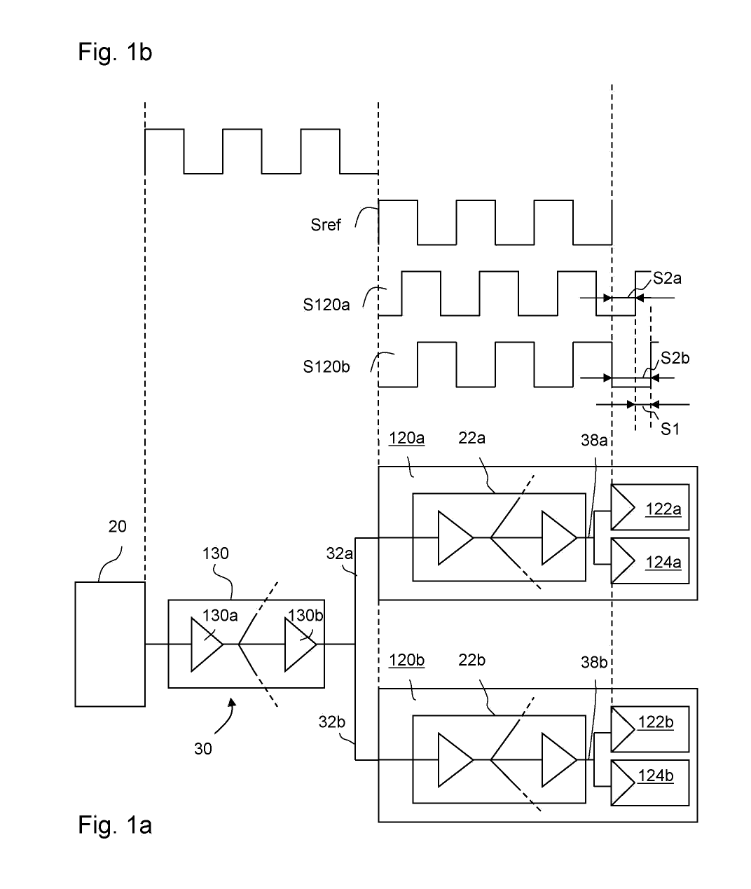

The drawings in FIGS. 1a, 1b exemplify how a global clock signal skew S1 develops between building blocks 120a, 120b which are arranged on a chip (not shown). The upper part of the figure (FIG. 1b) shows clock signals traveling from a clock signal generator 20, for example a phase locked loop (PLL), to the two blocks 120a, 120b. The dashed vertical lines serve as guide to the eye to highlight the influence to the blocks 120a, 120b on the particular clock signals Sref, S120a, S120b as well as their local and global clock signal skews S2a, S2b, and S1, respectively.

Ideally, the clock signal arrives at the same time at all clocked devices 122a, 124a, 122b, 124b in the blocks 120a, 120b. Due to physical constraints, such as chip dimensions, input capacitance, load and the like, the clock signal is buffered as a tree from the generator 20 to the clocked devices 122a, 124a, 122b, 124b and a big portion of the path is inside the blocks 120a, 120b. The tree is balanced so that the delays through the paths are almost the same so that the clock edges arrive at the clocked devices 122a, 124a, 122b, 124b almost at the same time. This balancing assumes that wire and buffer/device delays are the same throughout the chip. However, wire and device delays depend heavily on voltage and temperature. So if one block 122a or 122b drops voltage to save power or has less activity than the other and subsequently cools down, the clock signal delay differs from the other block 122b or 122a. Thus the clock edges drift apart and the clock skew becomes bigger which is explained in detail below.

The clock signal leaves the generator 20 (first dashed line) and travels through a clock path 30 to the blocks 120a, 120b, wherein the clock signal is repowered by several clock buffers 130a, 130b in a clock distribution or clock tree 130 in the clock path 30. Typically, such a global clock distribution 130 is not a single macro but comprises a multitude of clock buffers (symbolized as 130a and 130b) which can be distributed all over the chip. Additional to the global clock distribution 130, which delivers the clock signal to the blocks 120a, 120b, a local clock distribution 22a, 22b (also called clock mesh or clock tree) is provided in each of the blocks 120a, 120b.

The clock buffers 130a and 130b of the global clock signal distribution 130 cause a fixed delay (delay 0). The clock signal transmitted through this clock path 30 is used as clock signal for the blocks 120a, 120b, as well as a reference clock signal Sref. Behind the global clock tree 130 the clock signal is split and transmitted to block 120a via a interconnection 32a and to block 120b via a interconnection 32b (second dashed line). Physical constraints causing an individual local delay (skew S2a, S2b) in each of the blocks 120a, 120b are symbolized as clock distributions 22a and 22b, respectively, which also are symbolized each by two clock buffers each (not denoted separately). The interconnections 38a, 38b transmit the particular clock signals S120a, S120b to clocked devices 122a, 124a and 122b, 124b.

The reference clock signal Sref is provided for comparison with the clock signals of each block 120a, 120b after the local clock distributions 22a, 22b at the borderline of clocked devices 122a, 124a in block 120a and the clocked devices 122b, 124b in block 120b, respectively (third dashed line). The clocked devices 122a, 124a, 122b, 124b can be latches, flip-flops for example. As can be easily seen with the rising edges of the signals S120a, S120b, both clock signals S120a, S120b are shifted in phase relative to the reference signal Sref, which is indicated by arrows (fourths and fifths dashed lines). This leads to a global clock signal skew S1.

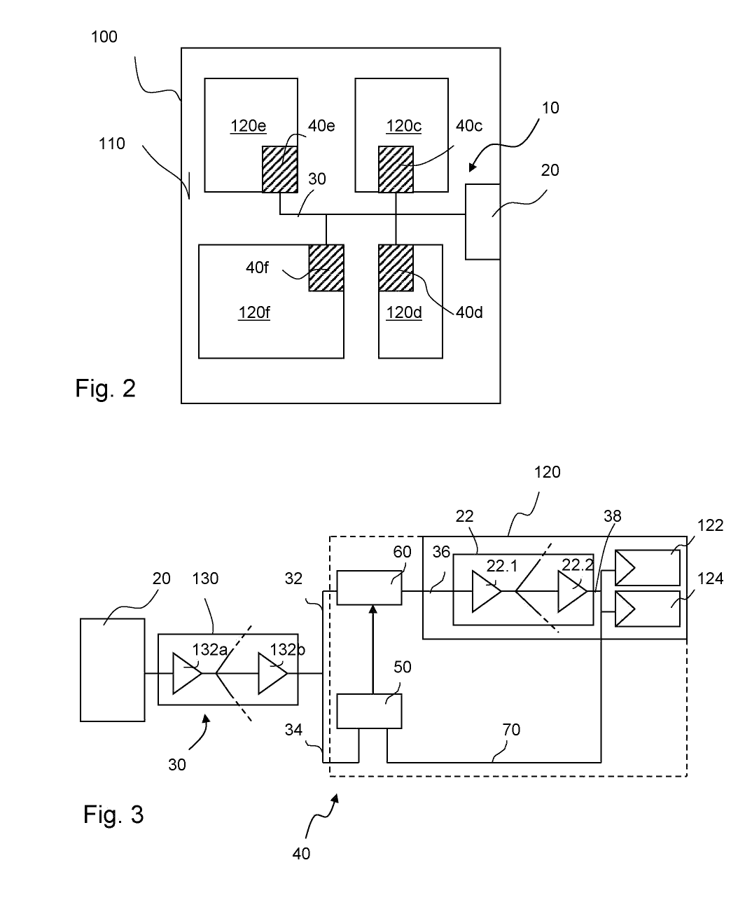

FIG. 2 depicts a top view of a preferred chip 100 which is subdivided into several blocks 120c, 120d, 120e, 120f arranged on the chip 100 as common substrate 110 with a common clock signal generator 20 which is the joint source of a clock signal for all blocks 120c, 120d, 120e, 120f. The clock signal generator 20 is connected to the blocks 120c, 120d, 120e, 120f via a clock path 30. To each of the blocks 120c, 120d, 120e, 120f is assigned a circuitry 40c, 40d, 40e and 40f, respectively. The circuitries 40c, 40d, 40e, 40f are connected to the clock path 30 and receive a clock signal from the joint clock signal generator 20.

The blocks 120c, 120d, 120e, 120f can be preplaced and prerouted from a former chip design.

A detailed sketch of a preferred embodiment of a clock signal skew adjustment arrangement is shown in FIG. 3. Only a single block 120 of a multitude of such blocks 120 is shown (see for example FIG. 2). The basic arrangement is similar to FIG. 1a with a joint clock signal generator 20 connected to a block 120 of a chip via a clock path 30. A global clock distribution or clock tree 130 with several clock buffers 132a, 132b is arranged in the clock path 30. Behind the clock distribution 130 the clock signal is split and is transmitted via connection 32 to a delay control circuit 60 and via a connection 34 to a detection circuit 50, where the signal is provided as reference clock signal (Sref in FIG. 1b).

From the delay control circuit 60 the clock signal is transmitted to a block 120 via connection 36 to clocked devices 122, 124, such as latches, flip-flops or the like. Between the delay control circuit 60 and the clocked devices 122, 124, a local clock distribution 22 is arranged with several clock buffers 22.1, 22.2, which symbolize constraints causing a local clock signal skew in the block 120.

From the inputs of the clocked devices 122, 124 at the end (line 38) of the clock path 30, 32, 36, 38 in this block 120 a feedback line 70 is led to the detection circuit 50 providing a clock signal feedback from the block 120 to the detection circuit 50.

The first step to compensate the skew between the reference clock signal and the clock signal of the block 120 is to measure the local skew. The feedback clock signal is compared to the reference clock signal in detection circuit 50 which preferably is a phase detection macro. Here, the reference clock signal is an on-chip reference clock signal. It also is possible, however, to use an external reference clock signal.

If the block 120 is run only at a fraction of the reference clock signal, such as ½, ⅓, ¼ etc., then the phases must be compared when both clock signals have a rising edge. From the measured local skew an adjustment can be determined and adjust signals can be generated for each individual block 120.

For each such block 120 a delay circuit 60, preferably being also a macro, is inserted in the clock path 32. The delay can be adjusted dynamically to compensate for the local clock signal skew. The delay value can be determined from the measured local skew. A logic can determine an adjust value from the stored state and fed to the delay circuit 60 which is indicated by an arrow from the detection circuit 50 to the skew delay circuit 60.

Preferably, the delay should be adjusted in small increments only so that the local clock signal frequency does not vary too much when it is adjusted.

The invention can be described further by means of some examples.

In the case the complete system on the chip 100 (FIG. 2) is powered up, all blocks 120 (blocks 120c, 120d, 120e, 120f in FIG. 2) are synchronized on system start-up. All static delays can be adjusted during power-on. Dynamic delays can be handled on-the-fly during operation of the blocks 120 (blocks 120c, 120d, 120e, 120f in FIG. 2).

One block 120 is powered on and off dynamically. After power on of the core of the block 120, the clock signal becomes enabled and propagates through the clock distribution 22. All devices 122, 124 (FIG. 3) are clock-gated at this time. Most probably, the local clock signal edge will differ from the rest of the chip 100 (FIG. 2) as this block 120 was powered down and is cooler than the rest of the chip area. The skew is measured and the delay is set to compensate for the skew. Once the local clock signal in the block 120 has been adjusted to the reference clock signal the clocked devices 122, 124 can be enabled and the block 120 is ready to operate.

One block 120 changes its supply voltage during a period of low activity. When the block 120 is not (much) used, frequency and voltage can be lowered to save power. When the voltage drops, the clock signal skew for this block will change. As the voltage changes, the skew is determined and the delay is adjusted on-the-fly to compensate for this change.

One block 120 shows high activity. The block 120 that is highly active becomes warmer than other areas on the chip 100 (FIG. 2). Subsequently, the clocked devices 122, 124 and the clock buffers of the clock distribution 22 slow down. As a result the delay through the clock path 36, 38 changes and this block's clock signal drifts away from the reference clock signal. As the clock signal skew changes, the delay is adjusted on-the-fly to compensate for this skew. So blocks with different activity and/or temperature can still be synchronized on the same clock signal phase.

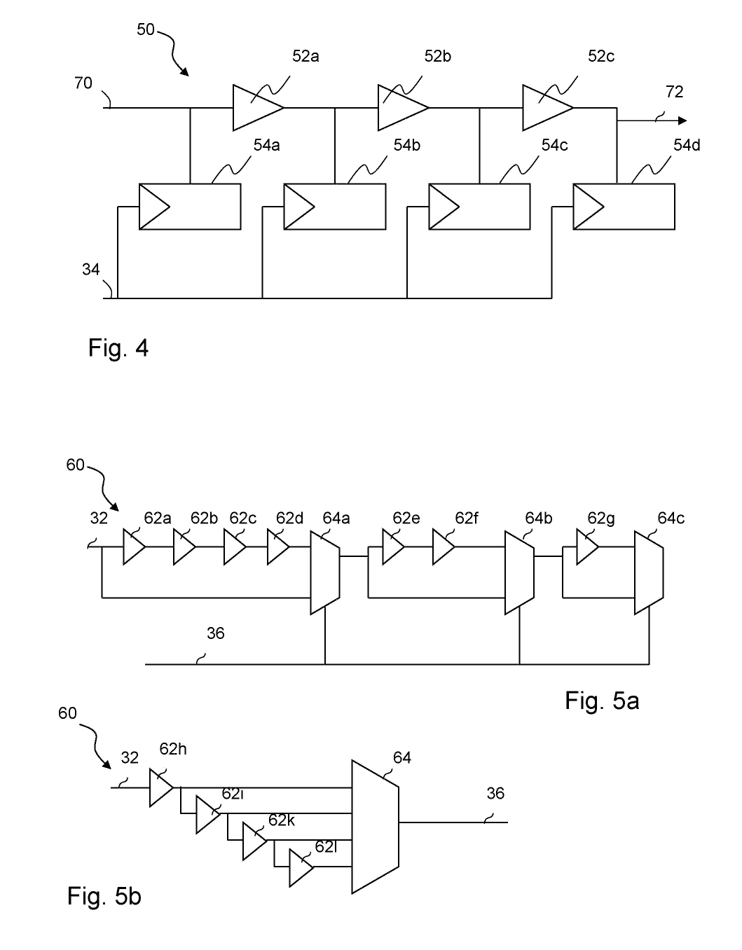

FIG. 4 depicts a preferred implementation of a detection circuit 50. A feedback clock signal (for example from block 120, FIG. 3) is supplied to line 70. A reference clock signal is fed into line 34. A signal edge can be detected by latching a history of the feedback signal. Beginning from feedback input line 70 a path of delay elements 52a, 52b, 52c is provided, where after each delay element 52a, 52b, 52c a storage element 54b, 54c, 54d, such as a latch or a flip-flop, stores the current state of the feedback signal. At the input, a separate storage element 54a is provided for storing the input state. A logic can determine an adjust value from the stored state.

Two examples for preferred embodiments of a delay circuit 60 are depicted in FIGS. 5a, 5b. The clock signal is fed in via line 32 and leaves the skew delay circuit 60 via line 38 which is the end of the clock path in the particular block. The delay circuit 60 can be realized by a path with different delay elements 62a . . . 62l. Different numbers of delay books, buffers and/or inverters are provided and a specific delay is selected by a multiplexer 64, 64a, 64b, 64c which selects the specific delay.

FIG. 5a depicts one embodiment where four delay elements 62a, 62b, 62c, 62d are assigned to a first multiplexer 64a. Two delay elements 62e, 62f are assigned to a second multiplexer 64b. One delay element 64g is assigned to a third multiplexer 64c. The multiplexers 64a, 64b, 64c with their delay elements 62a, 62b, 62c, 62d; 62e, 62f; 62g are electrically connected in series. For each group of delay elements 62a, 62b, 62c, 62d; 62e, 62f; 62g a by-pass without delay elements is connected to the particular multiplexer 64a, 64b, 64c. The outputs of the multiplexers 64a, 64b, 64c are connected to the output line 38 of the delay circuit 50.

FIG. 5a depicts another embodiment where only one multiplexer 64 is provided with multiple delay elements 62h, 62i, 62k, 2l are connected to the inputs of the multiplexer 64. One input of the multiplexer 64 is assigned to one delay element 62h, the next input is assigned to two delay elements 62h and 62i, the next input of the multiplexer 64 is assigned to three delay elements 62h, 62i and 62k, the next input of the multiplexer 64 is assigned to four delay elements 62h, 62i, 62k and 62l. Depending on the necessary delay, the multiplexer 64 switches the input line 32 to the output line 38 with the necessary number of delay elements 62h, 62i, 62k, 62l.

What is claimed is:

1. A clock skew adjustment arrangement for a computer chip, the clock skew arrangement comprising:
at least a first block and a second block, the first block and second block being supplied with a clock signal from a joint clock signal generator via clock signals paths, wherein to the first block and to the second block a circuitry is assigned for measuring and adjusting the respective clock signal.

2. The arrangement according to claim 1, wherein in that the circuitry comprises at least one clock-signal-skew detection circuit and at least one delay control circuit.

3. The arrangement according to claim 2, wherein the first block and the second block comprise a local clock mesh for distributing an incoming clock signal.

4. The arrangement according to claim 3, wherein at least one detection circuit is assigned to the first block and to the second block.

5. The arrangement according to claim 4, wherein the detection circuit comprises a path of delay elements and storage elements wherein after each delay element the current state of the local clock signal skew is stored.

6. The arrangement according to claim 5, wherein a reference clock signal is provided for triggering the storage elements.

7. The arrangement according to claim 6, wherein at least one delay control circuit is assigned to the first block and to the second block.

8. The arrangement according to claim 7, wherein each clock signal path to the first block and to the second block comprises one delay control circuit.

9. The arrangement according to claim 8, wherein the delay control circuit is configured to be dynamically adjustable.

10. The arrangement according to claim 9, wherein the detection circuit and the delay control circuit are arranged independently from each other on the computer chip.

11. The arrangement according to claim 10, wherein the delay control circuit comprises multiple paths with different delays which delays are selectable.

12. The arrangement according to claim 11, wherein the delay control circuit is integrated into a clock buffer.

13. The arrangement according to claim 12, wherein the detection and delay control circuits are integrated into the first block and into the second block.

14. A clock skew adjustment method for a computer chip subdivided into at least a first block and a second block wherein the first block and second block are supplied with a clock signal of a joint clock signal generator via clock signals paths, the method comprising:
measuring a local skew of the clock signal in the first block and the second block, and;
adjusting the global skew for the first block and for the second block.

15. The method according to claim 14, wherein the first block and the second block each supply a feedback clock signal which is compared to a reference clock signal in a detection circuit.

16. The method according to claim 15, wherein an adjustment of the global clock signal skew is estimated based on the comparison of the measured clock signal and the reference clock signal for the first block and for the second block.

17. The method according to claim 16, wherein a required clock signal delay is determined for the first block and for the second block for the adjustment of the global clock signal skew.

18. The method according to claim 17, wherein the local clock signal delay is adjusted in small increments so that a local clock signal frequency shows only tolerable variations during adjustment.

19. The method according to claim 18, wherein the local clock signal delay is adjusted dynamically.

20. The method according to claim 19, wherein the local clock signal skew is determined by means of a detection circuit comprising a path of delay elements, wherein after each delay element a storage element stores the actual state of the local skew.

21. The method according to claim 20, wherein the global clock signal skew is adjusted by means of a delay control circuit, wherein a specific delay is selected according to the local clock signal skew.
